(19) United States
(12) Patent Application Publication
(10) Pub. No.: US 2020/0373849 A1
(43) Pub. Date: Nov. 26, 2020

(54) POWER CONVERTER

(71) Applicant: ROLLS-ROYCE plc, London (GB)

(72) Inventors: Jih-Sheng LAI, Singapore (SG); Pabbathi VENKATESH, Singapore (SG); Xiong LIU, Singapore (SG)

(73) Assignee: ROLLS-ROYCE plc, London (GB)

(21) Appl. No.: 16/879,197

(22) Filed: May 20, 2020

(30) Foreign Application Priority Data
May 21, 2019 (GB) 1907146.3

(51) Int. Cl. H02M 7/08; H02M 1/12

(52) U.S. Cl. CPC H02M 7/08; H02M 2001/123; H02M 1/126

(57) ABSTRACT

A power converter. The power converter comprising: two or more multi-phase AC sources; an AC-DC converter circuit for each of the multi-phase AC sources, each AC-DC converter circuit being connected to a respective multi-phase AC source via a multi-phase input and configured to rectify a received multi-phase current into a DC current; a transformer, which is connected between the multi-phase AC inputs; a DC-link, shared between each of the AC-DC converter circuits; a load, connected to the DC-link and able to receive DC current therefrom; and a common mode filter, located within the DC-link, and configured to reduce a circulatory current which, when the power converter is in use, flows from the transformer through one of the AC-DC converter circuits, through the DC-link and through a further of the

AC-DC converter circuits back to the transformer.

### CROSS-REFERENCE TO RELATED APPLICATIONS

This specification is based upon and claims the benefit of priority from United Kingdom patent application number GB1907146.3 filed on 21 May 2019, the entire contents of which are incorporated herein by reference.

### BACKGROUND

### Technical Field

The present disclosure relates to a power converter, and particularly to a multi-phase power converter including a common mode filter.

### Description of the Related Art

The mass transportation industry, for example marine and aerospace industries, is moving to more electrical based systems in order to reduce operating costs, emissions, and noise. The adoption of more electrical systems also allows more flexibility in system design and operation.

For integrated power systems, there are prime mover engines which drive a generator and, downstream, an electrical motor driving a propeller or turbine. The power electronics, including an AC/DC/AC (or AC-AC) converter, is connected between the generator and the motor. This is because the AC current as generated by the generator may not be appropriate for the AC-driven motors downstream.

There are different topologies to build a front-end AC/DC converter between the generator and an intermediate DC-link. One distinct requirement for AC/DC converters is the ability to provide good input current waveform quality, especially with respect to suppression of the 5^{th} and 7^{th} order harmonic currents.

Further, there is generally a need for frequency converters to be provided in the propulsion units. Owing to stricter total harmonic distortion (THD) limitation at the generator terminal, there can be a need for harmonic compensation to be introduced. Typically, this is provided in large current systems through either: phase-shift transformers with passive front end rectifiers; or active front-end (AFE) rectifiers. However, a phase-shift transformer has a bulky low-frequency magnetic core (increasing system size and cost) and AFE rectifiers are costly and less efficient (incurring additional power losses).

Size and cost reduction can be achieved by using a partially rated shunt connected polygon autotransformer with two passive diode rectifiers in order to drive a dual drivetrain system. Such a system might include two generators which are synchronized but phase shifted by 30°.

### SUMMARY

FIG. 1 shows such a system, which is formed of a dual lane multi-phase system connecting two rectifying bridges. Here, dual lane means that there are two discrete multi-phase inputs, one for each generator which connects a respective generator to a respective rectifying bridge. Between the pair of multi-phase inputs is a shunt connected polygon autotransformer. In this configuration, when the DC-link of two rectifying bridges are connected together, there is a zero sequence circulating current 310 which flows through the transformer, rectifying bridges, and DC-link affecting the transformer harmonic trapping capability.

This is shown in FIGS. 2A-2D. In FIG. 2A, the AC power feed currents are shown which are highly distorted due to the harmonic circulating currents. FIG. 2B shows that the total harmonic distortion (THD) of the source current is around 23.2%. FIG. 2C shows the current through the DC rectifying bridges, which is also highly distorted. Similarly, FIG. 2D shows that the THD of the diode current is around 63.9% and it contains substantial amount of 3^{rd} order harmonic current.

Accordingly, there is a need to provide a dual lane multi-phase system with a shared DC-link which reduces the effects of circulating currents.

In a first aspect of the disclosure, there is disclosed a power converter, comprising:

two or more multi-phase AC inputs, connectable to respective multi-phase AC sources;

an AC-DC converter circuit for each of the multi-phase AC inputs, each AC-DC converter circuit being configured to rectify a received multi-phase current into a DC current;

a transformer, which is connected between the multi-phase AC inputs;

a DC-link, shared between each of the AC-DC converter circuits;

a load, connected to the DC-link and able to receive DC current therefrom; and

a common mode filter, located within the DC-link, and configured to reduce a circulatory current which, when the power converter is in use, flows from the transformer through one of the AC-DC converter circuits, through the DC-link and through a further of the AC-DC converter circuits back to the transformer.

Advantageously, such a power converter can suppress or reduce the circulatory current in power converters having a shared DC-link between a plurality of AC-DC converters, and therefore the current carrying capacity of the transformer used in such a converter can be reduced. The common mode filter acts in a similar manner to a pair of coupled inductors wound on the same magnetic core, with a strong coupling coefficient. The common mode filter therefore can provide a much higher impedance for common mode, or circulatory, currents whilst also providing minimal (and perhaps even negligible) impedance for differential mode currents.

The power converter may have any one or, to the extent that they are compatible, any combination of the following optional features.

The common mode filter may be positioned across a positive rail and a negative rail of the DC-link.

The transformer may be connected between at least two of the multi-phase inputs.

The load may be an AC load, and the power converter may be an AC-AC converter further comprising an inverter, connected between the DC-link and the AC load, the inverter being configured to provide AC power to the load by converting the DC current in the DC-link.

The common mode filter may comprise two inductive loops of wiring, one formed in a positive rail of the DC-link and one formed in a negative rail of the DC-link. The common mode filter may be formed in a region of the DC-link of a first AC-DC converter circuit or a second AC-DC converter circuit. The common mode filter may also be split into two filters with each connected to the DC-link of the first and second AC-DC converters. In such an example, the two filters may have half the capacity of the common mode filter which is not split into two. The inductive loops of wiring may be mutually coupled. The coupling coefficient k of the two coils may be described as:

$$k = \frac{M}{\sqrt{{L}_{1} \cdot {L}_{2}}}$$

where L₁ and L₂ are self-inductances of the two inductive loops of wiring, and M is the mutual inductance, and wherein k has a value of at least 0.97 and preferably at least 0.99 such that the two inductive loops of wiring are strongly coupled.

The transformer may be a polygon autotransformer.

The multi-phase inputs may be connected to respective multi-phase AC sources. The multi-phase AC sources may be respective multi-phase generators. The multi-phase AC sources may be separate windings form a single generator.

The AC-DC converter circuit is a six pulse diode rectification circuit.

The power converter may further comprise a capacitor connected between a positive rail and a negative rail of the DC-link.

In a second aspect of the disclosure, there is provided a propulsion system, including the power converter of the first aspect and including any, or any combination insofar as they are compatible, of the optional features as set out therein.

### DESCRIPTION OF THE DRAWINGS

Embodiments will now be described by way of example with reference to the accompanying drawings in which:

FIG. 1 is a circuit schematic illustrating a known dual-lane multi-phase system;

FIGS. 2A-2D are plots illustrating the electrical properties of the multi-phase system of FIG. 1;

FIG. 3 is a circuit schematic illustrating a power converter according to an embodiment; and

FIGS. 4A-4D are plots illustrating the electrical properties of the power converter shown in FIG. 3.s

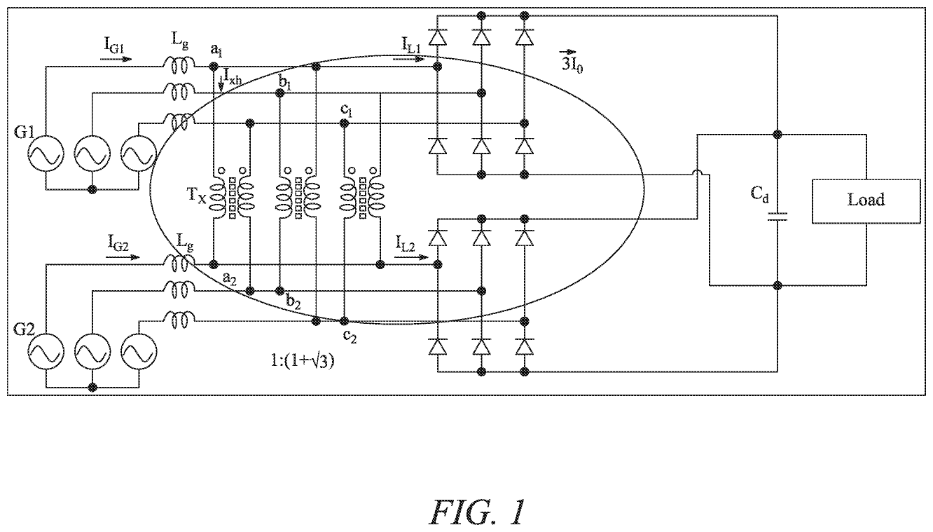

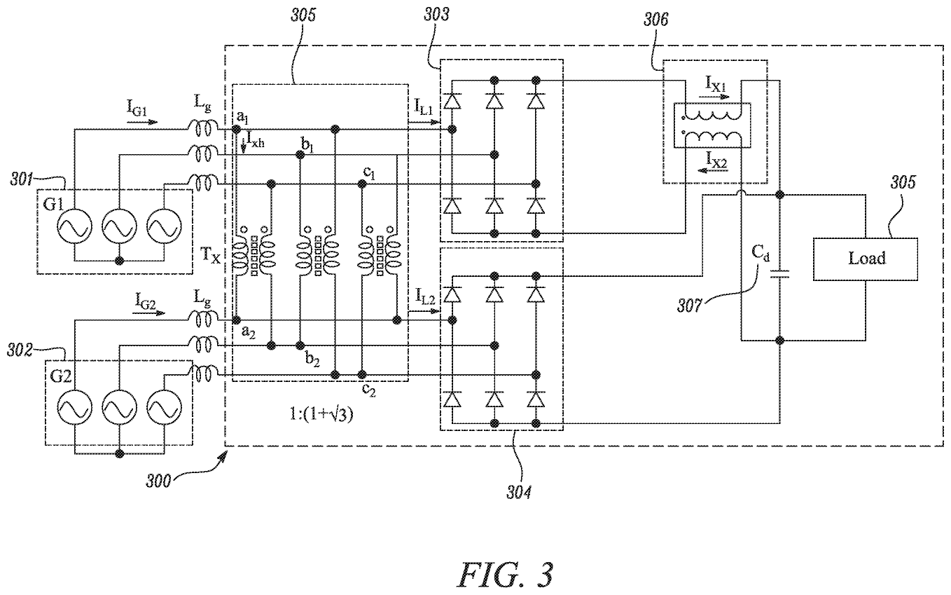

FIG. 3 shows a power converter 300. The power converter includes, or is coupled to, two 3-phase AC sources 301 and 302. In this example, the AC sources are synchronized but 30° out of phase. After passing through a respective inductors L_{g}, the phases from each AC source are provided to a multi-phase input. Each multi-phase input is formed of 3 rails, each rail receiving a phase of the multi-phase AC current.

### DETAILED DESCRIPTION

Pairs of rails between multi-phase inputs are connected by terminals of a shunt connected polygon transformer 305. In this example, as there are three phases from each AC source, the polygon transformer is connected to 6 terminals across the multi-phase inputs. The transformer 305 performs a voltage conversion in the standard manner.

The transformer 305 provides two 3-phase terminals, which are each connected to AC-DC converter circuits 303 and 304 and provide respective 3-phase currents. In this example, the AC-DC converter circuits are each provided as respective six-pulse rectifier diode bridges and convert the received multiphase AC currents into DC current. The AC-DC converter circuits 303 and 304 share a DC-link, to which the DC current is provided. A load 305 is connected to the DC link and receives the DC current. The load can include, in some examples, a DC-AC inverter, which provides single or multiphase AC current to, for example, one or more inductors motors.

Located within the DC-link is a common mode filter 306. The common mode filter is positioned across a positive and negative rail of the DC-link, and comprises two inductive loops of wiring. The two resulting inductors are strongly coupled. A capacitor 307 is also provided across the positive and negative rails of the DC-link, and serves to smooth the current rectified by the AC-DC converter circuits 303 and 304.

In use, as has been discussed previously, a common-mode circulating current can be present which flows from the transformer, through one of the AC-DC converter circuits 303 and 304, through the DC-link, and through the other of the AC-DC converter circuits back to the transformer. Of note, is that the common-mode circulating current is defined in part by the current circulating in the same direction on all lines. The common mode filter 306 suppresses this current.

The common mode filter 306 can be understood as two coupled inductors wound on the same magnetic core, with a strong coupling coefficient. The common mode filter acts in series suppressing the common mode currents (i.e. aiding the total inductance) whereas it acts in series eliminating the differential mode inductance.

If L₁ and L₂ are the self-inductances of the two coils, and M is the mutual inductance, the coupling coefficient can be expressed as:

$$k = \frac{M}{\sqrt{{L}_{1} \cdot {L}_{2}}}$$

Considering the first inductor of the common mode filter, the following can be derived:

I₁Z₁=I₁(R₁+jωL₁)+jωM·I₂

Similarly, considering the second inductor of the common mode filter, the following can be derived:

I₂Z₂=I₂(R₂+jωL₂)+jωM·I₁

Preferably, the common mode filter has a very strong coupling coefficient of almost 1, which results in:

L₁=L₂=M=L

Further, in the common mode current, the current I₁=I₂ , and so when neglecting resistance (R), the total impedance in the case of the common mode or circulating current is:

Z=Z₁+Z₂=L₁+L₂+2M==>4L

Whereas, in the differential mode current, the current I₁=I₂, again neglecting resistance the total impedance experienced by differential mode current is:

Z=Z₁+Z₂=L₁+L₂−2M==>4L

It can be concluded then that the common mode filter offers high impedance for the common mode or circulating currents, whereas it offers zero impedance for differential mode currents.

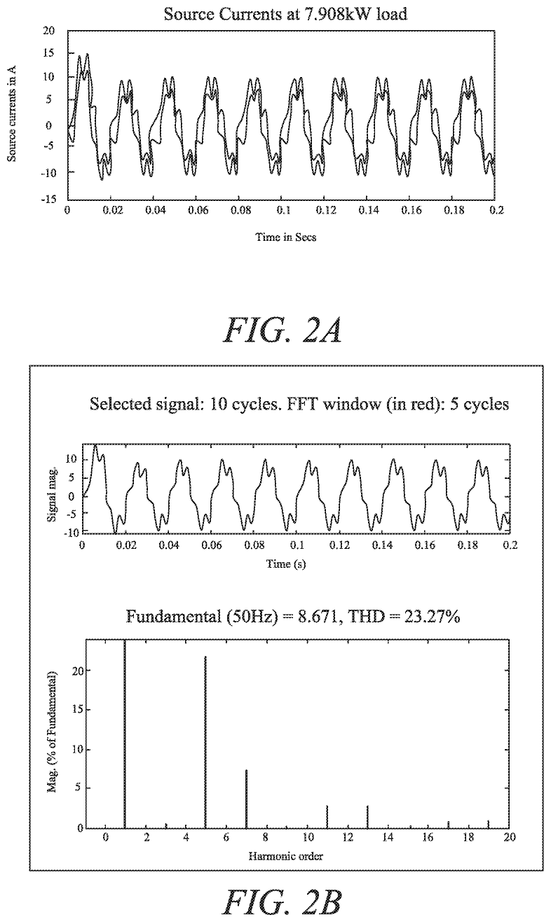

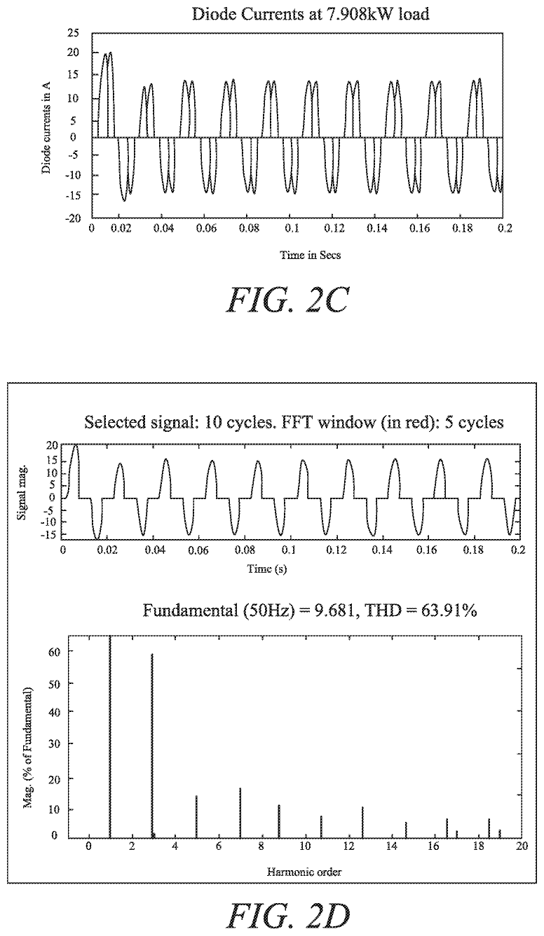

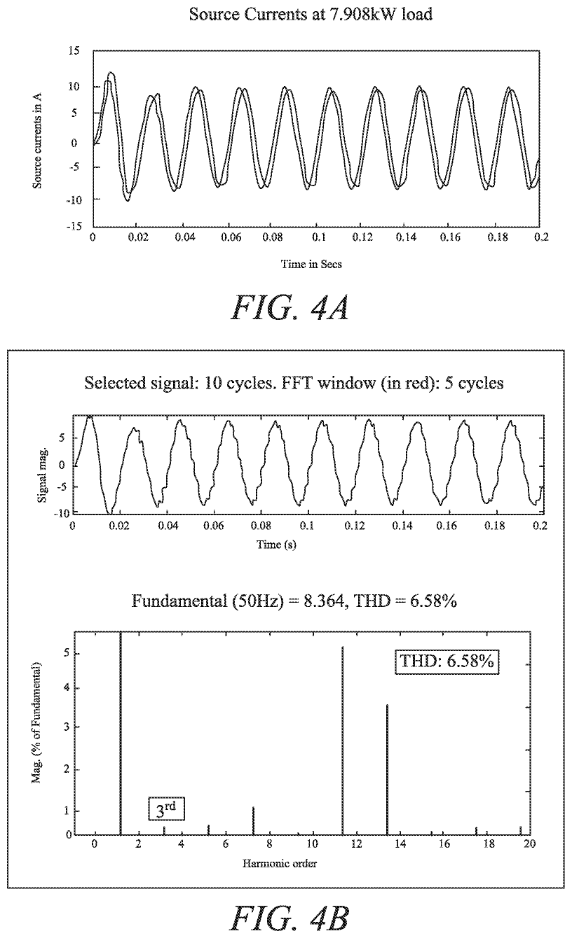

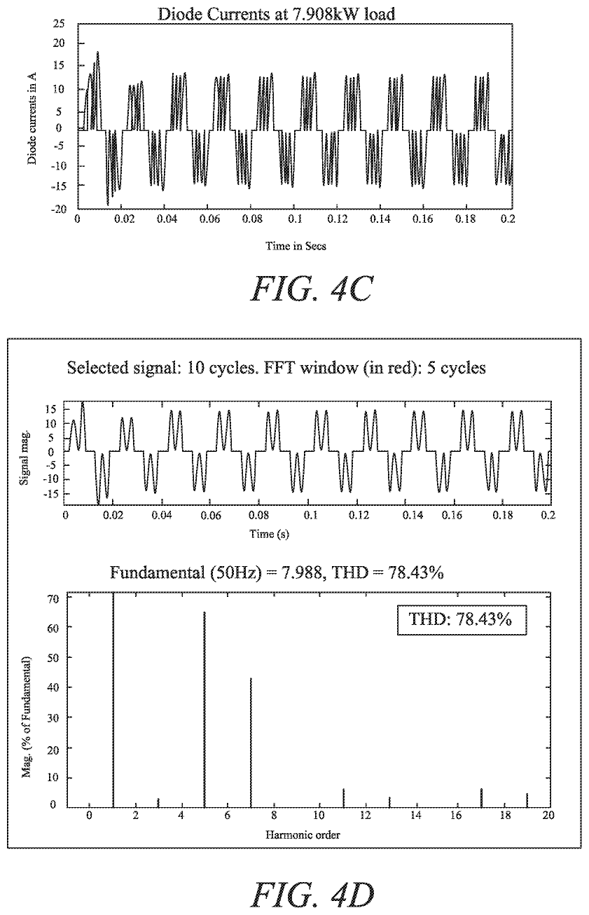

The results of this are shown in FIGS. 4A-4D, where the substantial reduction in the third harmonic circulating current can be seen (as compared to the results in FIGS. 2A-2D). Indeed, the AC power feed currents shown in FIG. 4A, as compared to 2A, show significantly less harmonic oscillation. This is through mitigation of the 5^{th} and 7^{th} harmonics, which is illustrated in FIG. 4B. The common mode filter also increases the effectiveness of harmonic mitigation using the shunt connected polygon transformer.

FIG. 4C shows the rectifying bridge AC current in the power converter shown in FIG. 3. FIG. 4B shows the THD analysis of the source current, and FIG. 4D shows the THD analysis of the diode rectifier phase current.

While the power converter has been described in conjunction with the exemplary embodiments described above, many equivalent modifications and variations will be apparent to those skilled in the art when given this disclosure. Accordingly, the exemplary embodiments set forth above are considered to be illustrative and not limiting. Various changes to the described embodiments may be made without departing from the scope of the disclosure.

1. A power converter, comprising:
two or more multi-phase AC inputs, connectable to respective multi-phase AC sources;
an AC-DC converter circuit for each of the multi-phase AC inputs, each AC-DC converter circuit being configured to rectify a received multi-phase current into a DC current;
a transformer, which is connected between the multi-phase AC inputs;
a DC-link, shared between each of the AC-DC converter circuits;
a load, connected to the DC-link and able to receive DC current therefrom; and
a common mode filter, located within the DC-link, and configured to reduce a circulatory current which, when the power converter is in use, flows from the transformer through one of the AC-DC converter circuits, through the DC-link and through a further of the AC-DC converter circuits back to the transformer.

2. The power converter of claim 1, wherein the common mode filter is positioned across a positive rail and a negative rail of the DC-link.

3. The power converter of claim 1, wherein the load is an AC load, and the power converter is an AC-AC converter further comprising an inverter, connected between the DC-link and the AC load, the inverter being configured to provide AC power to the load by converting the DC current in the DC-link.

4. The power converter of claim 1, wherein the common mode filter comprises two inductive loops of wiring, one formed in a positive rail of the DC-link and one formed in a negative rail of the DC-link.

5. The power converter of claim 4, wherein the common mode filter is formed in a region of the DC-link of a first AC-DC converter circuit or a second AC-DC converter circuit.

6. The power converter of claim 4, wherein the inductive loops of wiring are mutually coupled.

7. The power converter of claim 6, wherein a coupling coefficient k of the two coils is:
$$k = \frac{M}{\sqrt{{L}_{1} \cdot {L}_{2}}}$$
where L₁ and L₂ are self-inductances of the two inductive loops of wiring, and M is the mutual inductance, and wherein k has a value of at least 0.97 such that the two inductive loops of wiring are strongly coupled.

8. The power converter of claim 1, wherein the transformer is a polygon autotransformer.

9. The power converter of claim 1, wherein each multi-phase input is connected to a multi-phase AC source which is a multi-phase generator.

10. The power converter of claim 1, wherein each multi-phase input is connected to a multi-phase AC source is a separate winding from a single generator.

11. The power converter of claim 1, wherein each AC-DC converter circuit is a six pulse diode rectification circuit.

12. The power converter of claim 1, further comprising a capacitor connected between a positive rail and a negative rail of the DC-link.

13. A propulsion system, including the power converter of claim 1.
